(19) United States
(12) Patent Application Publication
(10) Pub. No.: US 2026/0264767 A1
(43) Pub. Date: Sep. 10, 2026

(54) ACCESS DEVICE FOR AN OPENING FORMED IN A WALL OF A MOTOR VEHICLE PART AND MOTOR VEHICLE

(71) Applicant: FLEXIS, BOULOGNE-BILLANCOURT (FR)

(72) Inventor: Alberto RAMOS, VILLIERS SAINT-FREDERIC (FR)

(21) Appl. No.: 19/556,273

(22) Filed: Mar. 4, 2026

(30) Foreign Application Priority Data
Mar. 6, 2025 (FR) FR2502267

(51) Int. Cl. B62D 25/24

(52) U.S. Cl. CPC B62D 25/24

(57) ABSTRACT

The access device includes: an access hatch configured to close off the opening when the access device is in the closed position, and configured to release said opening and provide access to a housing when the access device is in the open position; a retaining element for the access hatch, including a first end fixed to the access hatch and a second end configured to cooperate with the housing; wherein the second end of the retaining element is fixed to an inner wall of the housing so that the retaining element is taut when the access device is in the closed position.

### INCORPORATION BY REFERENCE TO ANY PRIORITY APPLICATIONS

Any and all applications for which a foreign or domestic priority claim is identified in the Application Data Sheet as filed with the present application are hereby incorporated by reference.

### FIELD

This present disclosure relates to the field of access hatches for motor vehicle parts comprising an opening, in particular hatches for covering access openings in bodywork parts. In particular, the present disclosure relates to an access device for an opening formed in a wall of a motor vehicle part. The present disclosure further relates to a motor vehicle equipped with such an access device.

### BACKGROUND

Motor vehicle bodies are generally fitted with openings covered by access hatches. For example, hatches covering an opening giving access to a fuel tank are known. These hatches can generally be rotated around a pivot link formed, for example, by a hinge.

Motor vehicles are also known to have a towing eye attached to the front bumper beam. An opening is then made in a bodywork part to allow access to the towing eye if necessary, for example to tow the vehicle when it breaks down. When the towing eye is not in use, a hatch covers the opening where the eye is located.

In order to connect this hatch to the vehicle bodywork, there are, for example, retaining elements designed to be inserted into a retaining passage provided for this purpose. At its free end, the retaining element is provided with a retaining anchor, which holds the hatch to prevent it from becoming detached from the vehicle when the hatch is no longer closing off the opening in the bodywork of said vehicle.

However, the techniques used to attach these vehicle access hatches are not entirely satisfactory: they can be cumbersome and/or awkward. In particular, the retaining element may hinder the user when closing off the hatch. The retaining element can sometimes become trapped between the edge of the opening in the bodywork and the edge of the hatch, creating an obstacle to closing off the hatch. Alternatively, if a free end of the retaining element fitted with a retaining anchor is to be inserted into a housing, manipulation of said retaining element may prove tedious for the user.

KR 2010 0018351 A describes an access device for an opening in a wall of a motor vehicle, comprising a hatch capable of closing off the opening in the closed position and releasing access to a housing in the open position. This device provides a retaining element, one end of which is slidably mounted on the hatch by means of a resilient element and a rail, the other end being secured to the housing, so that the element is tensioned when the hatch is closed.

DE 102 53 881 A1 discloses a hatch intended to close an opening formed in a wall of a motor vehicle, the hatch being mounted so as to pivot about an axis and capable of being locked in a frame surrounding the opening. The hatch comprises a hinged cover and an internal member, such as a pin or stud, designed to engage a complementary opening to ensure closure.

KR 2010 0018833 A relates to an anti-loss device for a motor vehicle fuel filler cap, designed to prevent loss of the cap while improving ease of refuelling, by means of a weight attached to a retaining strap connecting the cap to the bodywork.

### SUMMARY

The aim of the present disclosure is to remedy the disadvantages described above by offering a practical, economical and reliable solution with a limited number of parts.

To this end, the present disclosure relates to an access device for an opening formed in a wall of a motor vehicle part, in particular a bodywork wall, the opening forming an access to a housing inside the motor vehicle part, the access device comprising:

an access hatch configured to close off the opening in the wall of the motor vehicle part when the access device is in the closed position, and configured to release said opening giving access to the housing when the access device is in the open position;

a retaining element for the access hatch, the retaining element comprising a first end fixed to the access hatch and a second end configured to cooperate with the housing;

the access device being characterised in that the second end of the retaining element is fixed to an inner wall of the housing so that the retaining element is taut when the access device is in the closed position.

### In one embodiment:

the access hatch has an upper edge and a lower edge on the side opposite the upper edge, and in that the first end of the retaining element is fixed in an area adjoining the upper edge of the access hatch and/or in that the second end of the retaining element is fixed to the inner wall of the housing in the vehicle part in an area adjoining the edge of the opening;

the first end of the retaining element fixed to the access hatch is arranged opposite the second end fixed to the inner wall of the housing so that, in the closed position, the retaining element extends into a median zone of the access hatch;

the retaining element has an elongated and/or flattened shape;

the access hatch has an internal face intended to be oriented towards the inside of the housing when the access device is in the closed position and intended to be oriented towards an external face of the motor vehicle part when the access device is in the open position, the access hatch comprising at least one protective element arranged on said internal face;

the ends of the retaining element and/or an intermediate portion located between the ends of the retaining element are reinforced;

the first end and/or the second end of the retaining element has an eye configured to secure the end(s) of the retaining element in place;

the retaining element comprises a textile material;

the retaining element comprises a polymeric material such as polyoxymethylene.

The present disclosure further relates to a motor vehicle characterised in that it comprises a part comprising a wall in which is arranged an opening forming an access to a housing inside the part and in that it comprises an access device having the above characteristics for said opening, the second end of the retaining element being fixed to an inner wall of said housing so that the retaining element is taut when the access device is in the closed position.

### BRIEF DESCRIPTION OF THE DRAWINGS

These objects, features and advantages of the present disclosure will be set out in detail in the following description of a particular embodiment made by way of non-limitation in relation to the attached figures among which:

FIG. 1 is a schematic cross-sectional view of an access device in a preferred embodiment in the closed position.

FIG. 2 is a schematic cross-sectional view of the access device from FIG. 1 in the open position.

### DETAILED DESCRIPTION

In this description, the terms "first" and "second" etc. are not intended to imply or create any particular order of elements, or to limit an element to a single element, unless expressly stated, for example by using the terms "before", "after", "only" and the like. These terms are used to distinguish one element from another. For example, a first element is distinct from a second element, and the first element may encompass more than one element and succeed (or precede) the second element in an order of elements.

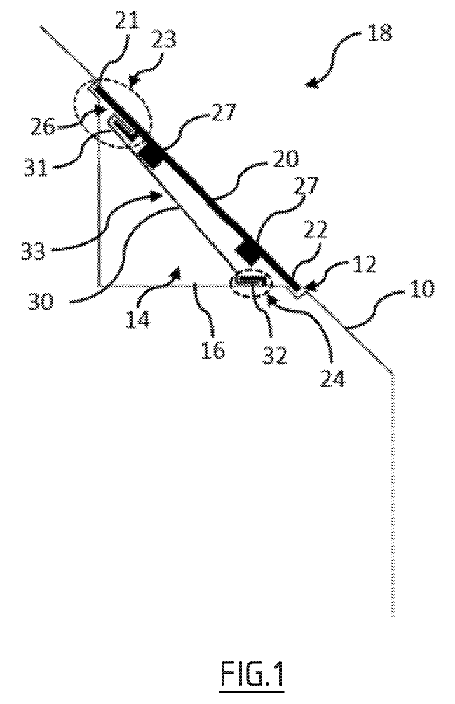

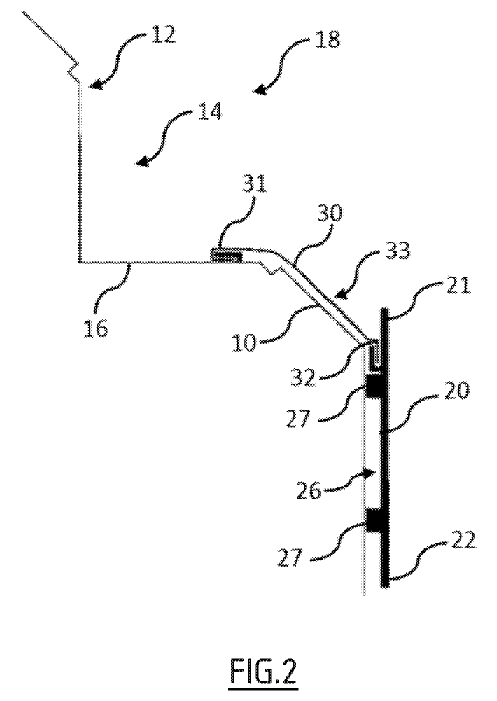

FIGS. 1 and 2 schematically illustrate a portion of a part 10 of a motor vehicle. This part 10 can, for example, be a bodywork part 10, in particular a motor vehicle bumper, but other types of part 10 can also be envisaged. The vehicle part 10 comprises a wall in which an opening 12 is formed. The opening 12 formed in the wall of the vehicle part 10 provides access to a housing 14 inside said part 10. For example, the opening 12 allows access to a fluid tank, in particular a windscreen washer fluid tank, or a fuel tank. However, such an opening 12 can be envisaged for other applications, for example to provide access to a towing eye in the front or rear bumper of a vehicle.

An access device 18 is provided to protect the opening 12 and the housing 14 from foreign matter coming in. This access device 18 comprises an access hatch 20 configured to close off the opening 12 in the wall of the motor vehicle part 10 when the access device 18 is in the closed position.

This closed position of the access device 18 is more particularly illustrated in FIG. 1. The access hatch 20 takes the form of a plate, for example, which may be elliptical or polygonal in shape. The opening 12 formed in the wall of the vehicle part 10 and the edges of the access hatch 20, or indeed the entire access hatch 20 generally, are shaped so that the access hatch 20 can be integrated substantially flush with the outer surface of the vehicle part 10. This is illustrated in FIG. 1. In particular, the access hatch 20 may be flat, or it may have one or more curves, so as to form a continuity with the outer surface of the vehicle part 10 when the access device 18 is in the closed position.

The access hatch 20 is also configured to release, in the open position, said opening 12 giving access to the housing 14. The open position is shown in FIG. 2. To prevent loss of the access hatch 20 when it does not cover the opening 12 formed in the wall of the vehicle part 10, the access device 18 also comprises a retaining element 30 for said access hatch 20.

In a preferred embodiment, the retaining element 30 has an elongated shape, in particular an slender shape. In this embodiment, the length of the retaining element 30 is much greater than its transverse dimensions, i.e. the length of the retaining element 30 is much greater than the width and thickness of said retaining element 30. The retaining element 30 is then similar to a cord.

Alternatively, the retaining element 30 may have a flattened shape, similar to a strap. In this embodiment, the width of the retaining element 30 is greater than its thickness. The flattened shape of the retaining element 30 gives it a good compromise between strength and compactness. In addition, a flattened shape can prevent the retaining element 30 from twisting when the access hatch 20 is in the open position.

Various materials can be used for the retaining element 30. The retaining element 30 may, for example, comprise a textile material. In one embodiment, at least part of the retaining element 30 may be in the form of a braided strap. Such a material for the retaining element 30 prevents damage to the bodywork when the retaining element 30 comes into contact with said bodywork when the access hatch 20 is in the open position.

In addition, a braided strap can impart a certain elasticity to the retaining element 30: the latter can, for example, tolerate a certain elongation in the direction of its length, which can facilitate the installation of the access hatch 20 on the opening 12 by allowing a certain tension on the retaining element 30 when the access device 18 is in the closed position.

Generally speaking, a textile material has the advantage of being lightweight, robust and economical. It can also be made of a flexible material, which gives the retaining element 30 a degree of flexibility. The softness and/or flexibility of the material of the retaining element 30 may be such that the retaining element 30 can be bent, without breaking, so that it protrudes from the opening 12 when the retaining device 18 is in the open position. In the embodiment illustrated in FIG. 2, the softness and/or flexibility of the material of the retaining element 30 allows the retaining element 30 to follow the geometry of the outer face of the part 10. In addition, a textile material makes it possible to give the retaining element 30 a flat, thin shape, which allows free access to the housing 14 inside said part 10.

In addition or alternatively, at least part of the retaining element 30 may comprise a polymeric material such as polyoxymethylene, or any other similar material. Polyoxymethylene is a low-aggression material and is therefore suitable for the intended use of the present disclosure, as it prevents damage to the outer surface of the part 10 if the retaining element 30 comes into contact with said surface of the part 10 of the vehicle.

In particular, the restraint element 30 may be in the form of a braided strap partially or entirely covered with a layer of polyoxymethylene, or partially or entirely covered with a layer of a polymer material similar to polyoxymethylene.

In a manner common to all the embodiments, the retaining element 30 comprises a first end 31 fixed to the access hatch 20 and a second end 32 configured to cooperate with the housing 14. More particularly, the second end 32 is configured to remain within the enclosure of the housing 14. To do this, the second end 32 of the retaining element 30 is fixed to an inner wall of the housing 14. In other words, the retaining element 30 is fixed on the one hand to the access hatch 20 and on the other hand to the inner wall of the housing 14. The access hatch 20 is then retained on an inner wall 16 of the housing 14 by the retaining element 30, so as to render the access hatch 20 captive. The retaining element 30 therefore provides a permanent or quasi-permanent link between the access hatch 20 and the tank fitted with such a hatch 20. This prevents the access hatch 20 from being lost when the access device 18 is in its open position.

According to a preferred embodiment illustrated in FIGS. 1 and 2, the access hatch 20 has, in particular, an internal face 26 intended to be oriented towards the inside of the housing 14 when the access device 18 is in the closed position, as illustrated in FIG. 1. This same internal face 26 of the access hatch 20 is intended to face the bodywork of the motor vehicle when the access device 18 is in the open position, as shown in FIG. 2. The first end 31 of the retaining element 30 is, for example, fixed to this internal face 26 of the access hatch 20.

In the embodiment illustrated in FIGS. 1 and 2, the access hatch 20 has an upper edge 21 and a lower edge 22 on the side opposite the upper edge 21. In a preferred embodiment, the first end 31 of the retaining element 30 is fixed in a zone 23 adjacent to the upper edge 21 of the access hatch 20. In FIG. 1, the area 23 adjacent to the upper edge 21 of the access hatch 20 is surrounded by a dotted line.

Alternatively, the first end 31 of the retaining element 30 can be fixed to the upper edge 21 of the access hatch 20. Other locations on the access hatch 20, in particular on the internal face 26, may be considered for securing the first end 31 of the retaining element 30.

In a manner common to all the embodiments, the second end 32 of the retaining element 30 is fixed to the inner wall of the housing 14. According to a preferred embodiment illustrated in FIGS. 1 and 2, the second end 32 of the retaining element 30 is more particularly fixed in a region 24 contiguous with the edge of the opening 12. In this preferred embodiment, the second end 32 of the retaining element 30 is therefore very close to the lower edge 22 of the access hatch 20 when the access device is in the closed position. In FIG. 1, the region 24 adjacent to the edge of the opening 12 is surrounded by a dotted line. Other locations on the inner wall of the housing 14 may be considered for securing the second end 32 of the retaining element 30.

In addition, the second end 32 of the retaining element 30 is fixed to the inner wall of the housing 14 so that the retaining element 30 is taut when the access device 18 is in the closed position. Thus, the locations of the ends 31, 32 of the retaining element 30 relative to the edges 21, 22 of the access hatch 20, and relative to the edge of the opening 12, make it easy to obtain tension on the retaining element 30 when the access device 18 occupies its closed position, in which it closes off access to the opening 12 in the vehicle part 10. The tension thus exerted on the retaining element 30 can help to hold the hatch 20 when the access device 18 is in the closed position, so as to prevent unwanted opening of the access device 18.

In addition, this same tension exerted on the retaining element 30 prevents it from folding, rolling up or bending when the access panel 20 is replaced on the opening 12, making it easier to handle.

When the access device 18 is in the closed position, the retaining element 30 may extend substantially parallel to the plane of the access hatch 20, as shown in FIG. 1. It should be noted that when the access device 18 is in the closed position, only one external face of the access hatch 20 is visible to an external observer; the access hatch 20 thus conceals the opening 12 and the retaining element 30 which is then located inside the housing 14. In other words, the retaining element 30 is not visible to an external observer when the access device 18 is in the closed position.

According to a preferred embodiment, the first end 31 of the retaining element 30 fixed to the access hatch 20 is arranged opposite the second end 32 fixed to the inner wall of the housing 14 so that, in the closed position, the retaining element 30 extends into a median zone of the access hatch 20. More particularly, the first end 31 of the retaining element 30 can be fixed in the middle of, or at least close to the middle of, the upper edge 21 of the access hatch 20, while the fixing point of the second end 32 of the retaining element 30, fixed to the inner wall of the housing 14, is arranged close to the middle of the lower edge 22 of the access hatch 20. Such an arrangement of fixing points for the ends 31, 32 of the retaining element 30 can contribute to the stability of the access hatch 20 when the access device 18 is in the closed position. When the access hatch 20 is in the closed position, the retaining element 30 may extend substantially parallel to the plane of the access hatch 20.

When the access device 18 is in an open position, the weight of the hatch 20 can exert tension on the retaining element 30. In other words, the retaining element 30 is taut under the effect of gravity when the access device 18 is in an open position. This is illustrated in FIG. 2. Advantageously, the arrangement of the fixing points for fixing the ends 31, 32 of the retaining element 30 makes it possible to move the access hatch 20 away from the opening 12 when the access device 18 is in the open position, without the risk of losing said access hatch 20.

Various fixing means can be envisaged for fixing the ends 31, 32 of the retaining element 30 to the access hatch 20 on the one hand and to the inner wall 16 of the housing 14 on the other. These fixing means can be non-removable, so that the ends 31, 32 of the retaining element 30 can be permanently fixed to the access hatch 20 and/or to the inner wall 16 of the housing 14. Alternatively, at least one of the fixing means may be removable, so as to enable the retaining element 30 to be separated. Such a removable fixing means can more particularly be envisaged for fixing the first end 31 of the retaining element 30 to the access hatch 20. In particular, this enables the access panel 20 to be replaced if it is damaged, e.g. deformed and/or scratched after an impact.

In one embodiment, the access device 18 may comprise clips or hooks for fixing the ends 31, 32 of the retaining element 30. Other fixing means enabling the first end 31 of the retaining element 30 to be fixed to the access hatch 20 and the second end 32 of the retaining element 30 to be fixed to the inner wall 16 of the housing 14 can be envisaged.

In one embodiment, the first end 31 and/or the second end 32 may comprise an eye for securing the retaining element 30 to the access hatch 20 and/or to the inner wall 16 of the housing 14. This embodiment allows the ends 31, 32 of the retaining element 30 to be quickly identified when the access device 18 is handled. This method also allows the retaining element 30 to be dismantled if necessary.

In one embodiment, the ends 31, 32 of the retaining element 30 can be reinforced. More specifically, the ends 31, 32 can be overmoulded to facilitate the cooperation of said ends 31, 32 of the retaining element 30 with the fixing points on the access hatch 20 and on the inner wall 16 of the housing 14. In particular, where the retaining element 30 comprises a textile material, overmoulding the ends 31, 32 of the retaining element 30 reinforces said ends 31, 32 and facilitates their cooperation with the fixing points for fixing the first end 31 to the access hatch 20 and for fixing the second end 32 to the inner wall 16 of the housing 14.

In addition and/or alternatively, an intermediate portion 33 located between the ends 31, 32 of the retaining element 30 can be reinforced. In particular, in the case where the geometry of the vehicle part 10 is such that the retaining element 30 comes into contact with the outer surface of said part 10 when the access device 18 is in the open position, the intermediate portion 33 of the retaining element 30 likely to come into contact with this outer surface can be overmoulded to protect said intermediate portion 33 against potential abrasion and/or to protect the bodywork against surface damage, such as dirt and/or scratches for example. Thus, in the case where the intermediate portion 33 of the retaining element 30 is in contact with the edge of the opening 12 formed in the wall of the vehicle part 10, for example, the overmoulding around this intermediate portion 33 protects the retaining element 30 against potential abrasion and also protects the wall of the part 10 against surface damage.

As previously indicated, the access hatch 20 has an internal face 26 intended to be oriented towards the inside of the housing 14 when the access device 18 is in the closed position. According to a preferred and optional embodiment, the access hatch 20 comprises at least one protective element 27 arranged on said internal face 26. The protective element(s) 27 is (are) in particular arranged at the edges of the hatch 20. If the access hatch 20 has a polygonal shape, the protective element(s) 27 is (are) for example arranged at the corners on the internal face 26.

In particular, the protective element(s) 27 may project from the internal face 26 of the access hatch 20, so as to create a distance between the hatch 20 and the part 10 of the vehicle against which the hatch 20 rests when the access device 18 is in the open position. This is illustrated in FIG. 2.

The protective element(s) 27 are configured to protect the outer surface of the part 10 from impacts between the access hatch 20 and said surface when the access device 18 is in the open position. The protective element(s) 27 may, for example, take the form of foam or rubber pads. Other materials and/or other embodiments can be envisaged for these protective elements 27.

This makes it possible to design a practical, compact, economical and reliable access device 18 for an opening 12 formed in a wall of a part 10 of a motor vehicle. This access device 18 requires a limited number of parts 10 and makes it possible, on the one hand, to maintain the aesthetic appearance of the motor vehicle when the access device 18 is in the closed position and, on the other hand, to avoid losing the access hatch 20 when the latter does not cover the opening 12 formed in the wall of the part 10 of the vehicle, while at the same time being very easy to handle.

What is claimed is:

1. An access device for an opening formed in a wall of a motor vehicle part, the opening forming an access to a housing inside the motor vehicle part, the access device comprising:
an access hatch configured to close off the opening in the wall of the motor vehicle part when the access device is in a closed position, and configured to release said opening giving access to the housing when the access device is in an open position; and
a retaining element for the access hatch comprising a first end fixed to the access hatch and a second end configured to cooperate with the housing,
wherein the access device the second end of the retaining element is fixed to an inner wall of the housing so that the retaining element is taut when the access device is in the closed position.

2. The access device according to claim 1, wherein the access hatch has an upper edge and a lower edge on a side opposite the upper edge, and wherein the first end of the retaining element is fixed in a region adjoining the upper edge of the access hatch and/or wherein the second end of the retaining element is fixed to the inner wall of the housing in the motor vehicle part in a region adjoining an edge of the opening.

3. The access device according to claim 2, wherein the first end of the retaining element fixed to the access hatch is arranged opposite the second end fixed to the inner wall of the housing so that, in the closed position, the retaining element extends in a median zone of the access hatch.

4. The access device according to claim 1, wherein the retaining element has an elongated and/or flattened shape.

5. The access device according to claim 1, wherein the access hatch has an internal face intended to be oriented towards an inside of the housing when the access device is in the closed position and configured to be oriented towards an external face of the motor vehicle part when the access device is in the open position, the access hatch comprising at least one protective element arranged on the internal face.

6. The access device according to claim 1, wherein the first and second ends of the retaining element and/or an intermediate portion located between the first and second ends of the retaining element are reinforced.

7. The access device according to claim 1, wherein the first end and/or the second end of the retaining element has an eye configured to secure the first end and/or the second end of the retaining element.

8. The access device according to claim 1, wherein the retaining element comprises a textile material.

9. The access device according to claim 1, wherein the retaining element comprises a polymeric material such as polyoxymethylene.

10. The access device according to claim 1, wherein the wall of the motor vehicle part is a bodywork wall.

11. A motor vehicle comprising:
a part comprising a wall comprising an opening forming an access to a housing inside the part; and
the access device according to claim 1 for said opening, the second end of the retaining element being fixed to the inner wall of the housing so that the retaining element is taut when the access device is in the closed position.

12. The motor vehicle according to claim 11, wherein the wall is a bodywork wall.
